(19) United States
(12) Patent Application Publication
(10) Pub. No.: US 2026/0067756 A1
(43) Pub. Date: Mar. 5, 2026

(54) SEAMLESS ROAMING SOLUTION FOR 5G CAPABLE USER EQUIPMENT (UE) IN HETEROGENEOUS NETWORK ENVIRONMENTS

(71) Applicant: DISH Wireless L.L.C., Englewood, CO (US)

(72) Inventors: Borong Zheng, Littleton, CO (US); Dawood Shahdad, Aurora, CO (US); Sundeep Goswami, Leesburg, VA (US)

(21) Appl. No.: 18/816,867

(22) Filed: Aug. 27, 2024

(51) Int. Cl. H04W 36/00; H04W 36/14

(52) U.S. Cl. CPC H04W 36/0033; H04W 36/144

(57) ABSTRACT

Technologies for seamless roaming of a fifth generation (5G) capable user equipment (UE) from a fourth generation (4G) home network to a 5G visited network are described. One method includes receiving, from an access and mobility management function (AMF) in the 5G visited network, a first data in a 5G context originated by a request from the 5G capable user equipment (UE) to use a 4G network service; converting the first data to a second data in a 4G context; sending, to the 4G home network, the second data; receiving, from the 4G home network, a third data in the 4G context, wherein the third data is a result of processing the second data by the 4G home network; converting the third data in the 4G context to a fourth data in the 5G context; and sending, to the AMF in the 5G visited network, the fourth data.

### BACKGROUND

As the technology of cellular networks is highly complex and continuously develops, a previous generation (e.g., fourth generation (4G) or long term evolution (LTE) cellular network) and a next generation (e.g., fifth generation (5G) new radio (NR) cellular network) may co-exist for a certain period of time. For example, 5G NR cellular networks have the promise to provide higher throughput, lower latency, and higher availability compared with previous global wireless standards. However, the transition from the service provided by 4G to the service provided by 5G NR may require further devolvement.

### BRIEF DESCRIPTION OF THE DRAWINGS

The present disclosure is illustrated by way of example, and not by way of limitation, in the figures of the accompanying drawings.

FIG. 1 is a block diagram of a system implementing seamless roaming solution for a next generalization cellular network capable user equipment (UE) in heterogeneous network environments according to at least one embodiment.

FIG. 2 is a block diagram of a system including interworking component that implements seamless roaming solution for a next generalization cellular network capable user equipment (UE) in heterogeneous network environments according to at least one embodiment.

FIGS. 3A, 3B, 3C, 4A, 4B, 4C, 5A, 5B, 5C, 6A, 6B, and 6C illustrate example implementations for seamless roaming solution for a 5G cellular network capable user equipment (UE) in heterogeneous network environments according to at least one embodiment.

FIGS. 7 and 8 are flow diagrams of example methods of seamless roaming solution for a 5G or next generalization cellular network capable user equipment (UE) in heterogeneous network environments according to at least one embodiment.

### DETAILED DESCRIPTION

Technologies for seamless roaming solution for a next generation cellular network (e.g., 5G wireless network, 6G wireless network) capable user equipment (UE) in heterogeneous telecommunication network environments are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

There is a technology gap in current telecommunications networks where 5G capable user equipment (UE) is unable to seamlessly roam from a 4G home network to a 5G visited network. Existing standards and industry solutions primarily cater to the reverse scenario from 5G home network to 4G visited network.

Aspects and embodiments of the present disclosure address the above and other deficiencies by providing a system that implements seamless roaming for 5G capable UE from a 4G home network to a 5G visited network. Specifically, the 5G capable UE can send a service request to the 5G visited network to use a 4G network service. The service request may include specific data (“first data”) that is in the 5G context. A component of the 5G visited network (e.g., interworking component) may receive, from an access and mobility management function (AMF) in the 5G visited network, through a specific 5G-side interface adapter, the first data in a 5G context. The component of the 5G visited network may convert the first data in the 5G context to corresponding data (“second data”) in a 4G context. Converting 5G context data to 4G context data may involve translating information from a 5G procedure into a 4G procedure, or converting a 5G identity to a 4G identity. After the conversion, the component of the 5G visited network may send, to the 4G home network, through a specific 4G-side interface adapter, the second data in the 4G context. The corresponding component of 4G home network may process the second data to obtain processed data (“third data”) that is in the 4G context, for example, a response to the requested 4G network service. The component of the 5G visited network may receive, from the 4G home network, through a specific 4G-side interface adapter, the third data in the 4G context. The component of the 5G visited network may convert the third data in the 4G context to corresponding data (“fourth data”) in the 5G context. Converting 4G context data to 5G context data may involve translating information from a 4G procedure into a 5G procedure, or converting a 4G identity to a 5G identity. After the conversion, the component of the 5G visited network may send, to the AMF in the 5G visited network, through a specific 5G-side interface adapter, the fourth data in the 5G context. As such, the AMF in the 5G visited network processes the service request from the 5G capable UE as if the service request is handled in the 5G visited network, but in fact, through communication and information relay between 5G visited network and 4G home network and processing in the 4G home network.

In one example, the service request is a UE registration and authentication request, the first data is received via an authentication server function (AUSF) adaptor or a unified data management (UDM) adaptor, the second data is sent via a mobility management entity (MME) interface adaptor, the third data is received via the MME interface adaptor, and the fourth data is received via the AUSF adaptor or the UDM adaptor.

In another example, the service request is a user plane based packet data unit (PDU) session request, the first data is received via a session management function (SMF) adaptor, the second data is sent via a mobility management entity (MME) interface adaptor, the third data is received via the MME interface adaptor, and the fourth data is received via the SMF adaptor.

In yet another example, the service request is a control plane based packet data unit (PDU) session request, the first data is received via a session management function (SMF) adaptor, the second data is sent via a mobility management entity (MME) interface adaptor, the third data is received via the MME interface adaptor, and the fourth data is received via the SMF adaptor.

In yet another example, the service request is a short message service request, the first data is received via a short message service function (SMSF) adaptor, the second data is sent via a mobility management entity (MME) interface adaptor, the third data is received via the MME interface adaptor, and the fourth data is received via the SMSF adaptor.

Aspects and embodiments of the present disclosure can provide multiple logical interworking functions that facilitates seamless roaming while ensuring full 3GPP compliance and compatibility with existing network elements. Aspects and embodiments of the present disclosure can improve system performance and cost-efficiency by providing interworking function that facilitates seamless integration and interaction between the 5G capable UE, 5G gNB, and the 4G home network.

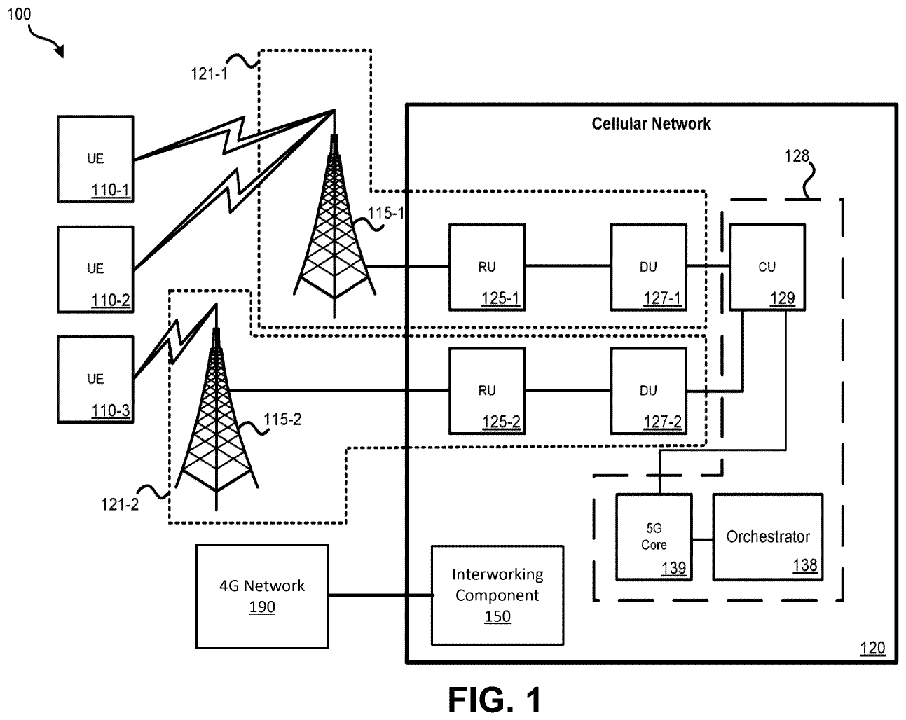

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) (e.g., AMF 234) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF) (e.g., manage UE context and network handovers between base stations).

User plane function (UPF) can be responsible for packet routing and forwarding, packet inspection, QoS handling, and external PDU sessions for interconnecting with a data network (DN) (e.g., data network) (e.g., the Internet) or various access networks. Access networks can include the RAN of cellular network 120.

The SMF may configure or control the UPF via the N4 interface. For example, the SMF may control packet forwarding rules used by the UPF and adjust QoS parameters for QoS enforcement of data flows (e.g., limiting available data rates). In some cases, multiple SMF/UPF pairs may be used to simultaneously manage user plane traffic for a particular user device, such as UE 210. For example, a set of SMFs may be associated with UE 210, where each SMF of the set of SMFs corresponds with a network slice. The SMF may control the UPF on a per end user data session basis, in which the SMF may create, update, and remove session information in the UPF.

Decoupling control signaling in the control plane from user plane traffic in the user plane may allow the UPF to be positioned in close proximity to the edge of a network compared with the AMF. As a closer geographic or topographic proximity may reduce the electrical distance, the electrical distance from the UPF to the UE 210 may be less than the electrical distance of the AMF to the UE 210.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

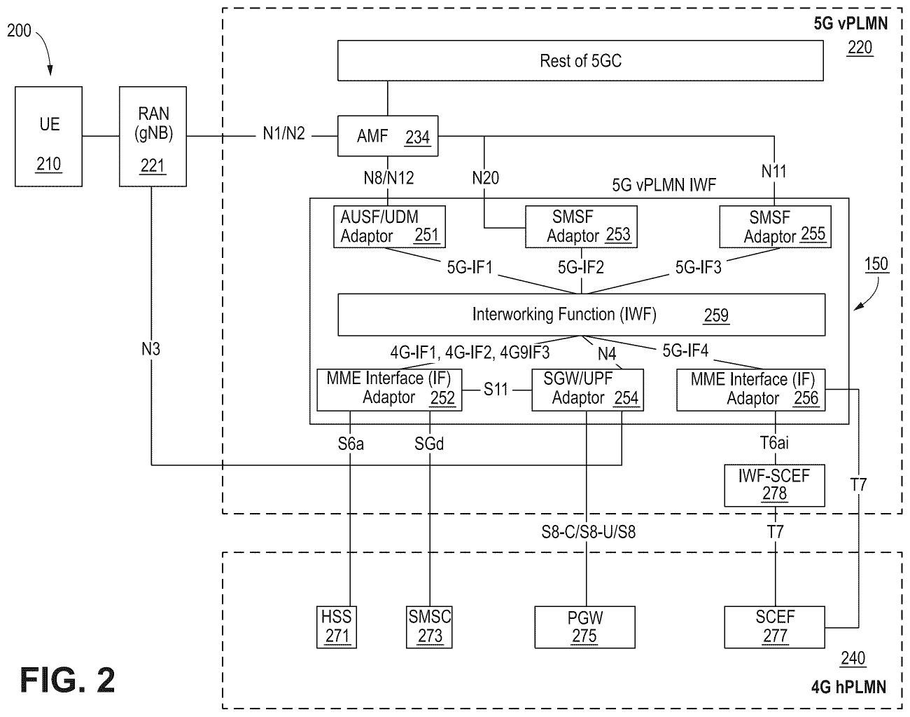

In some embodiments, the cellular network 120 includes an interworking component 150 that implements roaming from a 4G home network to a 5G visited network. In some embodiments, the interworking component 150 is part of the 5G core 139. Further details regarding the operations of the interworking component 150 are described below with reference to FIGS. 2-8.

FIG. 2 is a block diagram of example roaming from a 4G home network to a 5G visited network according to at least one embodiment. Referring to FIG. 2, a system 200 includes UE 210, radio access network (RAN) 221, a first core network 220, and a second core network 240 according to at least one embodiment. In at least one embodiment, the first core network 220 can be implemented as the 5G visited public land mobile network (vPLMN). In at least one embodiment, the second core network 240 can be implemented as the 4G home public land mobile network (hPLMN). In at least one embodiment, UE 210 has a 5G capability, which means that UE 210 is capable of connecting to 5G network. In at least one embodiment, UE 210 uses 4G hPLMN as a home service, and visits 5G vPLMN for a roaming service.

The UE 210 can include an electronic device with wireless connectivity or cellular communication capability, including mobile computing device such as a mobile phone or handheld computing device, and non-mobile computing device. In at least one example, the UE 210 can include a 5G smartphone or a 5G cellular device that connects to the RAN 221 via a wireless connection. The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

Referring to FIG. 2, UE 210 connects the 5G vPLMN via the RAN 211 to the data network (not shown), and the data network can include the Internet, a local area network (LAN), a wide area network (WAN), a private data network, a wireless network, a wired network, or a combination of networks. The RAN 221 includes a remote radio unit (RRU) for wirelessly communicating with UE 210. The RRU can include a Radio Unit (RU) and may include one or more radio transceivers for wirelessly communicating with UE 210. The RRU may include circuitry for converting signals sent to and from an antenna of a Base Station into digital signals for transmission over packet networks. The RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) and the centralized unit (CU) of the RAN 221 may be co-located with the RRU. In other embodiments, the DU and the RRU may be co-located at a cell site and the centralized unit (CU) may be located within a local data center (LDC). The DU can include a logical node configured to provide functions for the radio link control (RLC) layer, the medium access control (MAC) layer, and the physical layer (PHY) layers. The centralized unit (CU) can be partitioned into a CU user plane portion (CU-UP) and a CU control plane portion (CU-CP). The CU-CP may perform functions related to a control plane, such as connection setup, mobility, and security. The CU-UP may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 328 can include a logical node configured to provide functions of the control plane part of the RRC and PDCP. The centralized unit for the user plane(CU-UP) 326 can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mm Wave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The 5G vPLMN 220 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The 5G vPLMN 220 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) (e.g., AMF 234), the session management function (SMF), and the user plane function (UPF). The AMF may interface with UE 210, act as a single-entry point for a UE connection, and perform mobility management, registration management, and connection management between data network and UE 210. The AMF may interface with the SMF to track user sessions. The AMF may interface with a network slice selection function (NSSF) to select network slice instances for user equipment. When user equipment is leaving a first coverage area and entering a second coverage area, the AMF may be responsible for coordinating the handoff between the coverage areas whether the coverage areas are associated with the same radio access network or different radio access networks. The SMF may perform session management, user plane selection, and Internet Protocol (IP) address allocation. After the Access Gateway Function (AGF) authenticates the subscriber and establishes a protocol data unit (PDU) session, the SMF may select the UPF for the subscriber.

The UPF may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF may serve as an ingress and egress point for user plane traffic and provide anchored mobility support for user equipment. The UPF may be implemented as a software process or application running within a virtualized infrastructure or a cloud-based compute and storage infrastructure.

The UPF may transfer downlink data received from the data network to the UE 210, via the RAN 221 and/or transfer uplink data received from the UE 210 to the data network via the RAN 221. An uplink can include a radio link though which UE 210 transmits data and/or control signals to the RAN 221. A downlink can include a radio link through which the RAN 221 transmits data and/or control signals to the UE 210.

Uplink packets arriving from the RAN 221 may use a general packet radio service (GPRS) tunneling protocol (or GTP) to reach the UPF. The GPRS tunneling protocol for the user plane may support multiplexing of traffic from different PDU sessions by tunneling user data over the interface N3 between the RAN 221 and the UPF. The UPF may remove the packet headers belonging to the GTP tunnel before forwarding the user plane packets towards the data network. As the UPF may provide connectivity towards other data networks in addition to the data network, the UPF ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the 5G vPLMN 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, an application function (AF) providing application services, and a short message service function (SMSF) providing messaging services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The 5G vPLMN 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the RAN 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

AMF 234 may be connected to SMF, PCF, UDM, AUSF, and NSSF via different interfaces. AMF 234 may be connected to SMF via an N11 interface. AMF 234 may be connected to PCF via an N15 interface. AMF 234 may be connected to UDM via an N8 interface. AMF 234 may be connected to AUSF via an N12 interface. AMF 234 may be connected to NSSF via an N22 interface. The RAN 221 may be connected to the AMF 234, which may allocate temporary unique identifiers, determine tracking areas, and select appropriate policy control functions (PCFs) for user equipment, via an N2 interface. The N2 interface may be used for transferring control plane signaling between the RAN 221 and the AMF 234. The UE 210 may be connected to the SMF via an N1 interface, which may transfer UE information directly to the AMF 234 and an N11 interface. In addition, although not shown in FIG. 2, AMF 234 may be connected to evolved packet data gateway (ePDG), where ePDG can be connected through non-3Gpp based access network (e.g., untrusted WLANs) to UE 210, and therefore the interface includes multiple network connections.

The UPF may be connected to the data network via an N6 interface. The N6 interface may be used for providing connectivity between the UPF and other external or internal data networks (e.g., to the Internet). In some cases, the data may not be tunneled across the N6 interface as IP packets may be routed based on end user IP addresses.

The UPF may connect to the SMF via the N4 interface. The N4 interface may be used for catering for a number of key session management procedures. The UPF may receive, from SMF, via N4 interface, the necessary instructions in order to control and deliver the desired QoS. For example, the UPF may identify and transport user plane traffic information and flow based on session management data received from the SMF. Each subscriber's interaction with services (in other words, the traffic the user generates) can be described as a subscriber session, and since subscriber sessions may have different QoS requirements and the context that is required for each subscriber session is known and set, the SMF may create, update, and remove the contexts for subscriber sessions in the UPF. The SMF does this via policy rules which, in turn, are obtained from the PCF and other nodes and delivers to the UPF via the N4 interface.

The N3 Interface may be used for transferring user data (e.g., user plane traffic) from the RAN 221 to the UPF and may be used for providing low-latency services using edge computing resources. The electrical distance from the UPF (e.g., located at the edge of a network) to user equipment, such as UE 210, may impact the latency and performance services provided to the user equipment. The data may be tunneled across the N3 Interface (e.g., IP routing may be done on the tunnel header IP address instead of using end user IP addresses). This may allow for maintaining a stable IP anchor point even though UE 210 may be moving around a network of cells or moving from one coverage area into another coverage area.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G vPLMN 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 4G hPLMN 240 may include mobility management entity (MME) (not shown), serving gateway (SGW) (not shown), packet data network gateway (PGW) 275, home subscriber server (HSS) 271, short message service center (SMSC) 273, service capability exposure function (SCEF) 277. MME may manage idle mode UE tracking process, manage paging process, manage bearer activation/deactivation process, choose the SGW for a UE at the initial attach, manage core network node relocation at time of intra-LTE handover, manage authentication of UE (by interacting with the HSS), manage destination of NAS message, manage generation and allocation of temporary identities to UEs, manage authorization of the UE to camp on the service provider's PLMN, enforces UE roaming restrictions, manage termination point for ciphering/integrity for NAS signaling, manage security key, manage lawful interception of signaling, etc.

SGW may route and forward user data packets, act as the mobility anchor for the user plane during inter-eNodeB handovers, act as the anchor for mobility between LTE and other 3GPP technologies, terminate the downlink data path and trigger paging when downlink data arrives for the UE when UE is in idle mode, manages and store UE contexts, e.g. parameters of the IP bearer service, network internal routing information, perform replication of the user traffic in case of lawful interception, etc.

PGW may provide connectivity from the UE to external packet data networks, perform policy enforcement, packet filtering for each user, charging support, lawful Interception and packet screening, act as the anchor for mobility between 3GPP and non-3GPP technologies such as WiMAX and 3GPP2 (CDMA 1X and EvDO).

HSS may be a central database that contains user-related and subscription-related information. SMSC may store, forward, convert and deliver Short Message Service (SMS) messages. SCEF may be a server that securely exposes the servers and capabilities provided by 3GPP network interfaces.

The interworking component 150 may ingest the connection-related and/or session-related information from the AMF 234 (e.g., through one or more 5G-side adapters within the interworking component 150), convert the information in a 5G context to corresponding information in a 4G context, and provide the converted 4G context information (e.g., through one or more 4G-side adapters within the interworking component 150) to the 4G hPLMN 240 for processing. The interworking component 150 may receive the processed information from the 4G hPLMN 240, convert the processed information that is in the 4G context to corresponding information in the 5G context, and send the converted 5G context information back to AMF 234 (or other component of 5G). As such, AMF 234 send and receive the information all in 5G context without the conversion to/from 4G context and information processing under 4G network. In some implementations, the interworking component 150 may include an interwinding function (IWF) 259, the 4G-side adapters, and the 5G-side adapters.

In some implementations, the interworking component 150 may include an interwinding function (IWF) 259 to convert information in 4G context to information in 5G context. Converting information in 4G context to information in 5G context may involve translating information from 4G procedures into 5G procedures, converting 4G identities to 5G identities, and performing interface adaption from 4G domain to 5G domain, In some implementations, the interworking component 150 may maintain the life cycle management of 5G and/or 4G context and session state.

In some implementations, the interworking component 150 may perform the interface adaption between 5G network and 4G network through one or more 5G-side adapters and one or more 4G-side adapters. Referring to FIG. 2, the 5G-side adapters may include AUSF/UDM adaptor 251, SMSF adaptor 253, SGW/UPF adaptor 254, and SMF adaptor 255; the 4G-side adapters may include MME interface adaptor 252, SGW/UPF adaptor 254, and MME interface adaptor 256.

AUSF/UDM adaptor 251 may present 3GPP compliant N8 and N12 interface for UE authentication, registration, and user subscription and service profile management. SMSF adaptor 253 may present 3GPP compliant N20 interface to AMF 234 for short message service (SMS) over non access stratum (NAS) services. SMF adaptor 255 may present 3GPP compliant N11 interface to AMF 234 for both user plane based and control plane based PDU session management.

SGW/UPF adaptor 254 may present UPF adaptor facing towards gNB with 3GPP compliant 5G N3 interface and SGW adaptor facing towards 4G hPLMN with 3GPP compliant 4G user plane S8-U interface and control plane S8-C interface. 5G user plane is bridged between N3 and S8-U interface, whereas S8-C interface faces PGW in 4G vPLMN domain for 4G PDU session management. The data session established via S8-U user plane carries home routed voice traffic, data traffic, MMS traffic, as well as SMS over IP traffic to hPLMN domain.

MME interface adaptor 252, 256 may present roaming interface to 4G hPLMN via 3GPP compliant 4G S6a interface and SGd interface. S6a interface integrates with 4G HSS in hPLMN for UE authentication, registration, subscription, and service profile management. SGd interface integrates with SMSC in hPLMN for SMS over NAS service. The MME interface adaptor 252, 256 may also provide 3GPP compliant T6ai interface towards interworking function (IWF)-service capability exposure function (SCEF) 278 integration in the 5G vPLMN. IWF-SCEF 278 provides T7 integration with 4G hPLMN SCEF function to support control plane based PDU session for home routed roaming. IWF-SCEF 278 is a standard 4G network function deployed in 5G vPLMN for the purpose of 4G roaming integration. In some implementations, IWF-SCEF 278 may integrate with MME interface adaptor 252, 256 via T6ai interface. Alternatively, IWF-SCEF 278 may also be implemented as part of MME interface adaptor 252, 256, where MME Interface adaptor will integrate with 4G SCEF in hPLMN via T7 interface directly.

As described above, to ensure adherence to 3GPP standards for both 5G and 4G networks, the 5G vPLMN IWF provides the following full 3GPP compliant interfaces N8, N12, N20, N11, N4, 5G interfaces S6a, SGd, S8-C, S8-U (or S8 in case of PGW is control plane and user plane combined deployment), T6ai or T7 in case of IWF-SCEF being deployed as part of MME interface adaptor, and N3 Interface

Internal Interfaces between components of interworking component 150 may include a mix of proprietary and standard interfaces that are between interface adaptors and IWF 259, including 5G-IF1, 5G-IF2, 5G-IF3, 4G-IF1, 4G-IF2, 4G-IF3, 4G-IF4, S11, and N4 interfaces.

5G-IF1 is an interface between AUSF/UDM adaptor 251 and IWF 259. IWF 259 may ingest from AUSF/UDM adaptor 251 the N8/N12 session information, state, identities, and UE context and convert them to corresponding 4G procedures. IWF 259 may also take input from MME interface adaptors 252, 256 and convert them to corresponding N8/N12 5G procedures which AUSF/UDM adaptors 251 will forward to AMF 5G-IF2 is an interface between SMSF adaptor 253 and IWF 259. IWF 259 may ingest from SMSF adaptor 253 the N20 session information, state, identities, and UE context and convert them to corresponding 4G procedures. IWF 259 may also take input from MME interface adaptors 252, 256 and convert them to corresponding N20 5G procedures which SMSF adaptors 253 will forward to AMF 5G-IF3 is an interface between SMF adaptor 255 and IWF 259. IWF 259 may ingest from SMF adaptor 255 the N11 session information, state, identities, and UE context and convert them to corresponding 4G procedures. IWF 259 may also take input from MME interface adaptors 252, 256 and convert them to corresponding N11 5G procedures which SMF adaptors 255 will forward to AMF. 4G-IF1 is an interface between MME interface adaptor 252 and IWF 259. IWF 259 may ingest from MME interface adaptor 252 the S6a session information, state, identities, and UE context and convert them to corresponding 5G procedures. IWF 259 may also take input from AUSF/UDM adaptor 251 and convert them to corresponding S6a 4G procedures which MME interface adaptor 252 will forward to 4G hPLMN.

4G-IF2 is an interface between MME interface adaptor 252 and IWF 259. IWF 259 may ingest from MME interface adaptor 252 the SGd session information, state, identities, and UE context and convert them to corresponding 5G procedures. IWF 259 may also take input from SMSF adaptor 253 and convert them to corresponding SGd procedures, which MME interface adaptor 252 will forward to 4G hPLMN.

4G-IF3 is an interface between MME interface adaptor 252 and IWF 259. IWF 259 may ingest from SGW adaptor 254 the S11 session information, state, identities, and UE context and convert them to corresponding UP PDU 5G procedures. IWF 259 may also take input from SMF adaptor 255 and convert them to corresponding S11 4G procedures, which MME interface adaptor 252 will forward to SGW adaptor 254.

4G-IF4 is an interface between MME interface adaptor 256 and IWF 259 to support CP PDU sessions. IWF 259 may ingest from MME interface adaptor 256 the 4G T6ai or T7 session information, state, identities, and UE context and convert them to corresponding 5G procedures. IWF 259 may also take input from SMF adaptor 255 N11 interface and convert them to corresponding T6ai or T7 4G procedures, which the MME interface adaptor 256 and/or IWF-SCEF 278 will forward towards 4G hPLMN.

S11 interface is a standard 4G interface that is deployed between MME interface adaptor 252 and SGW adaptor 254 to facility User Plane (UP) PDU session setup towards the 4G hPLMN.

N4 Interface is a standard 5G interface between IWF 259 and UPF adaptor 254 to create the 5G user plane tunnel for UP PDU sessions.

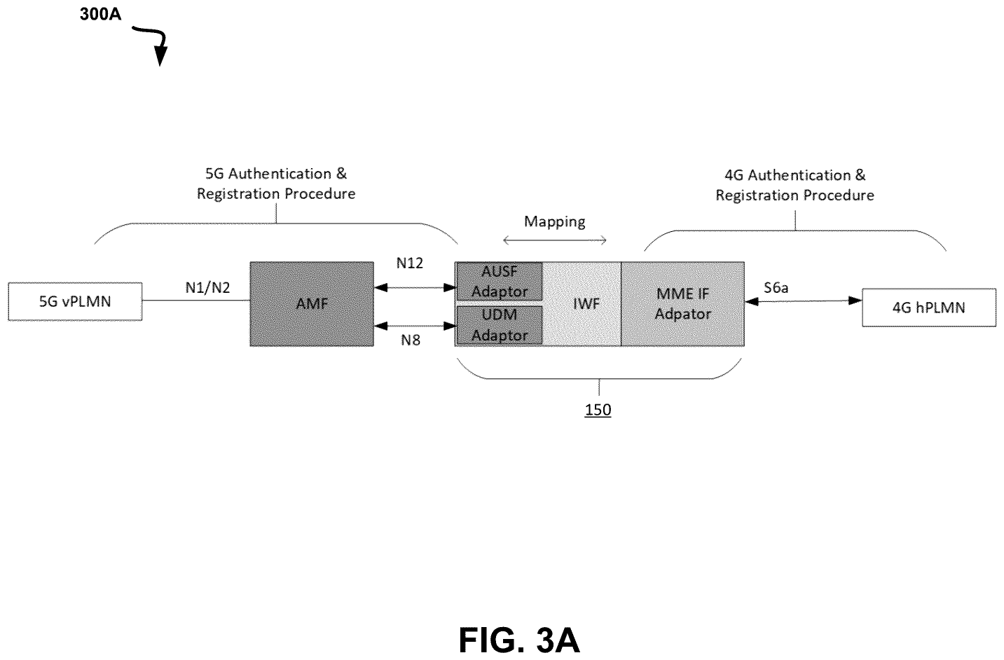

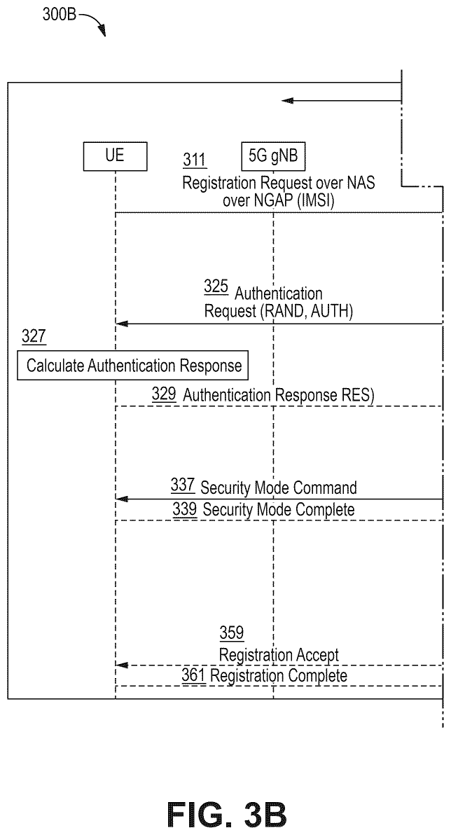

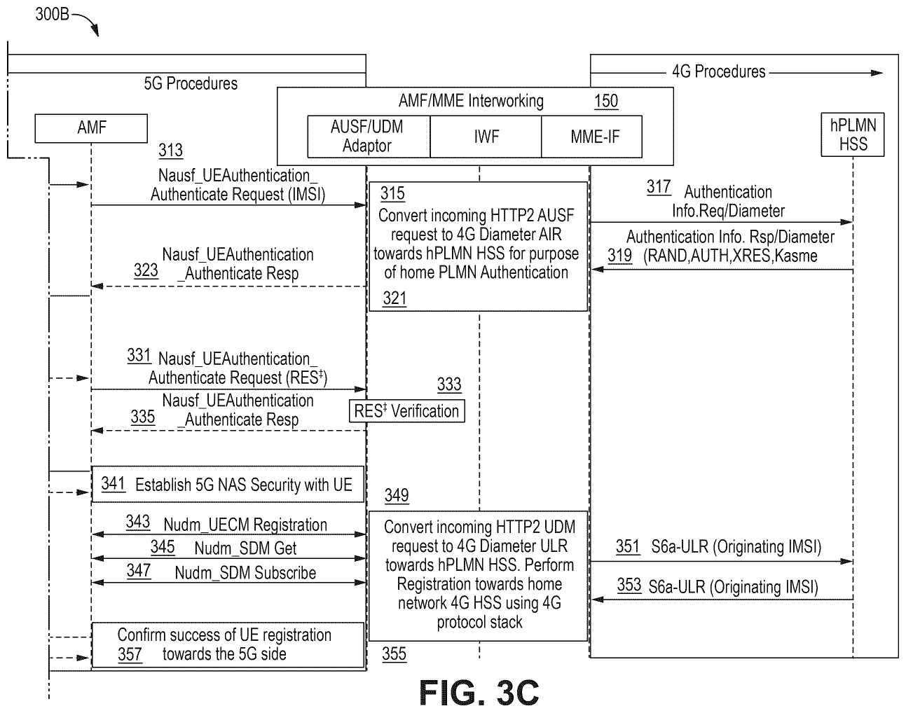

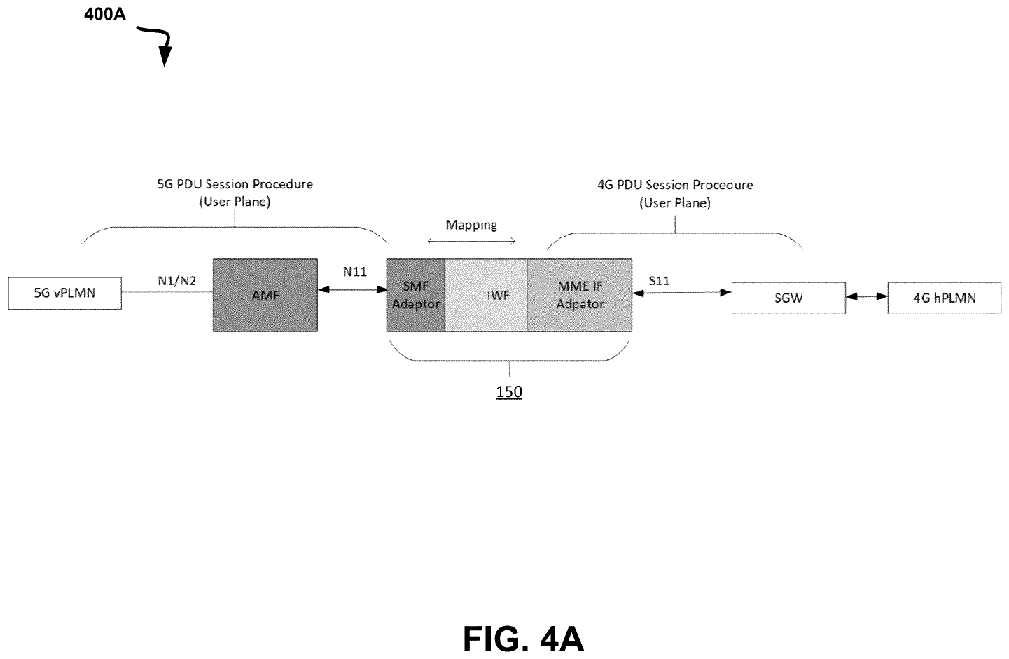

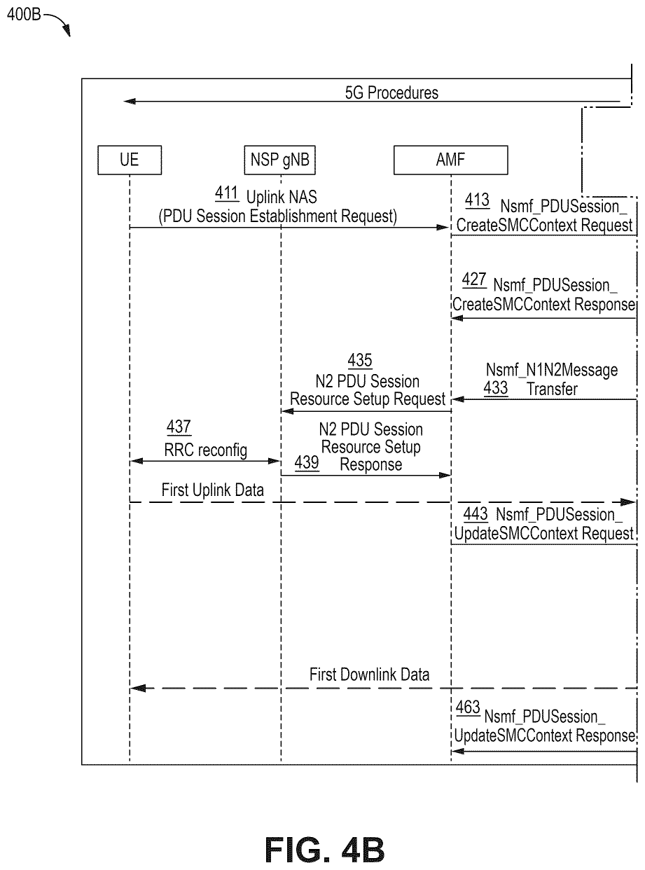

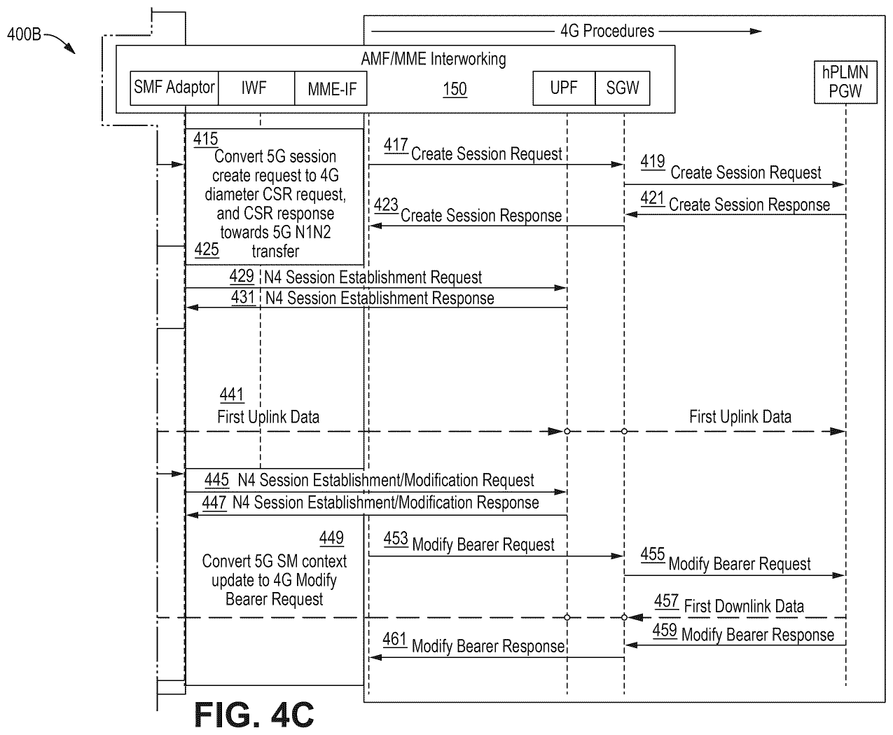

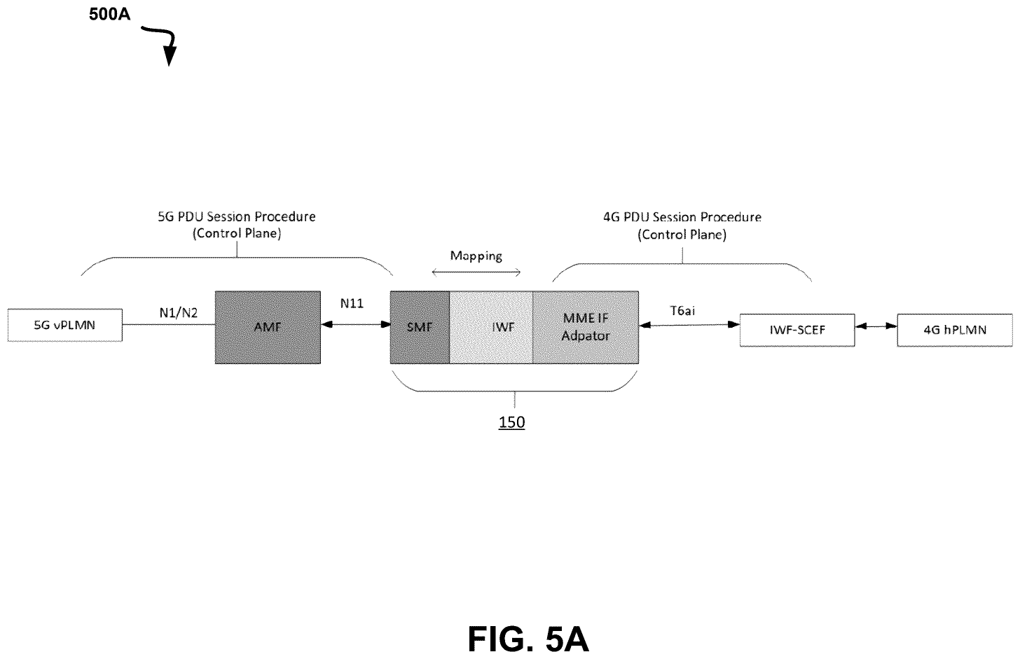

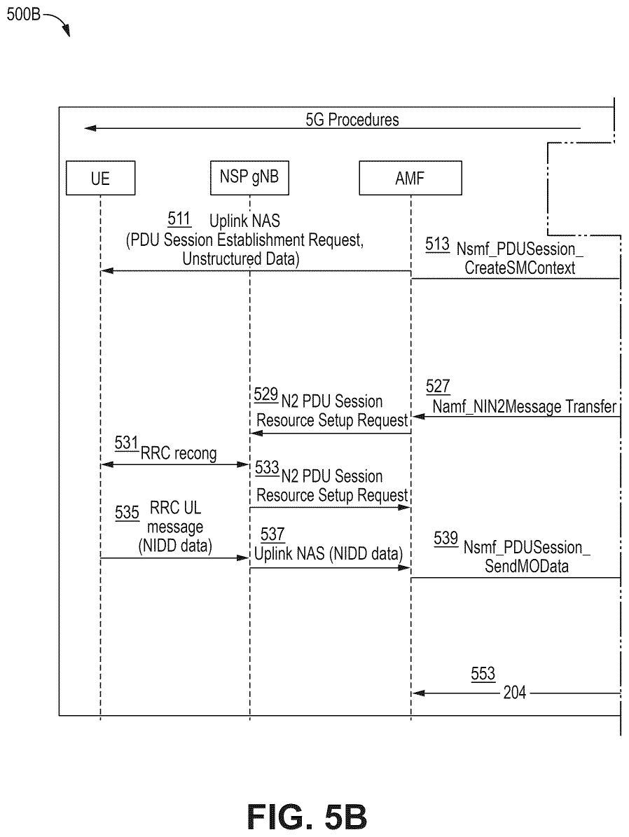

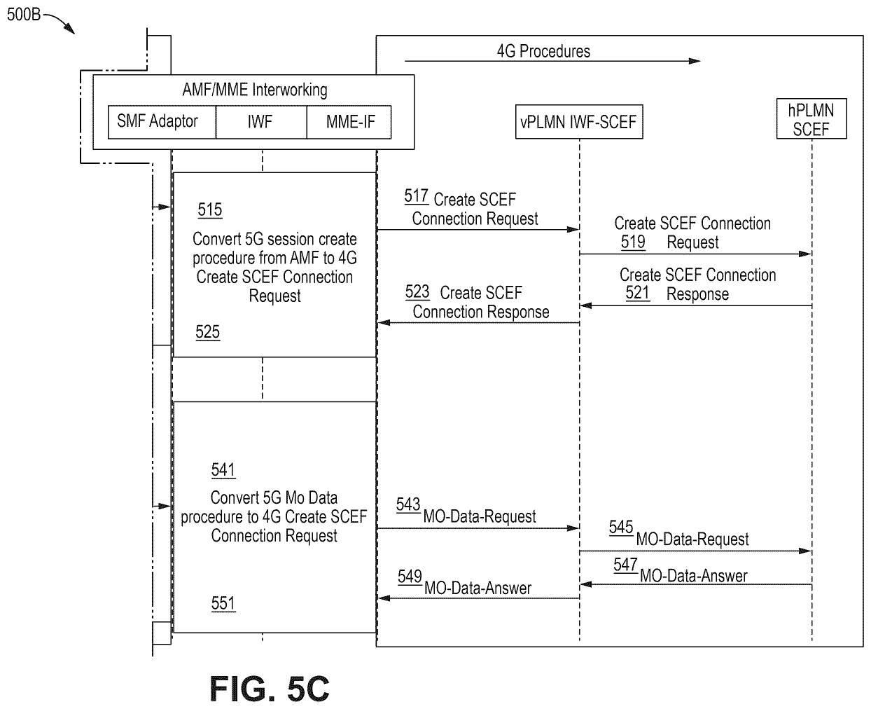

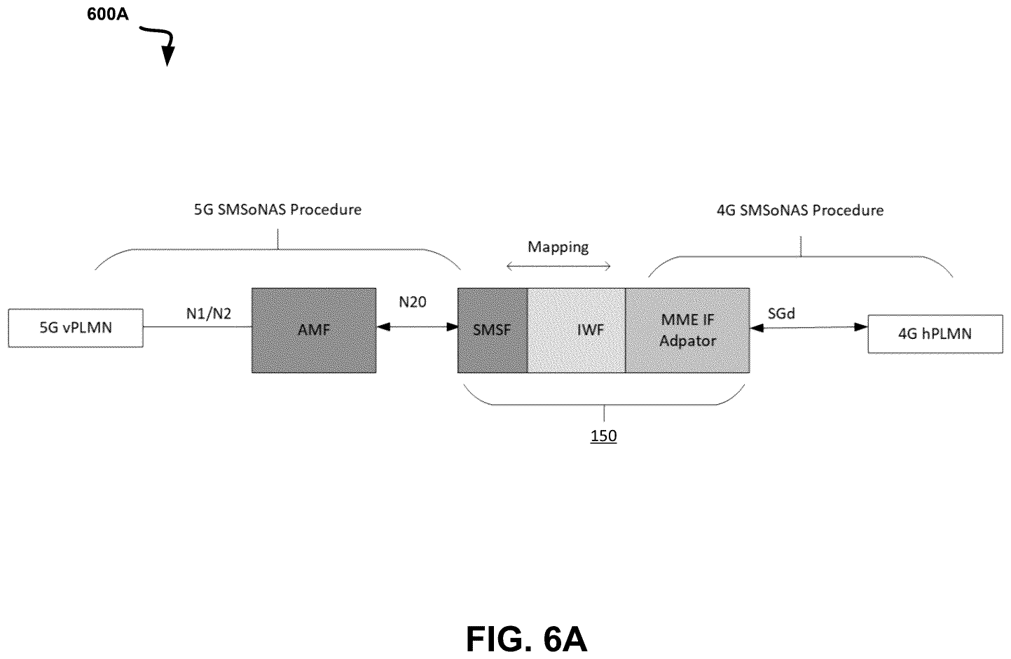

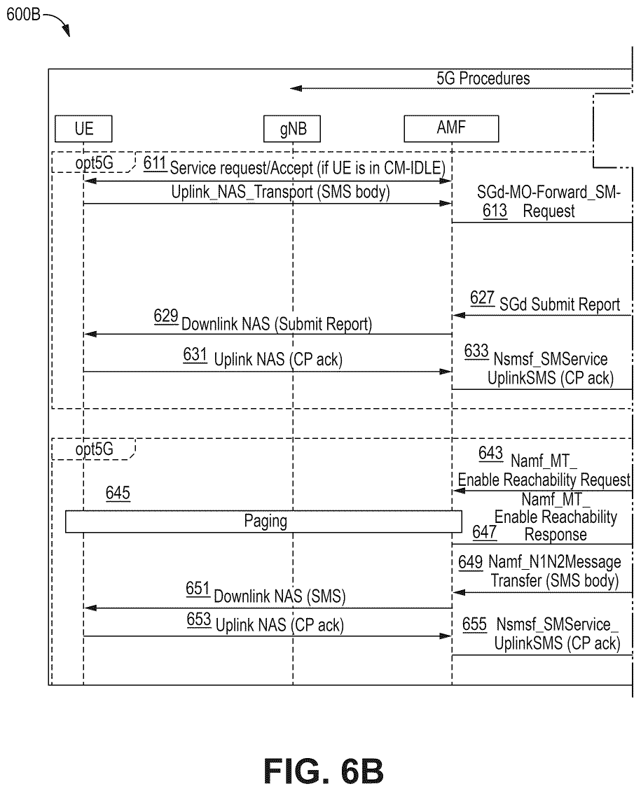

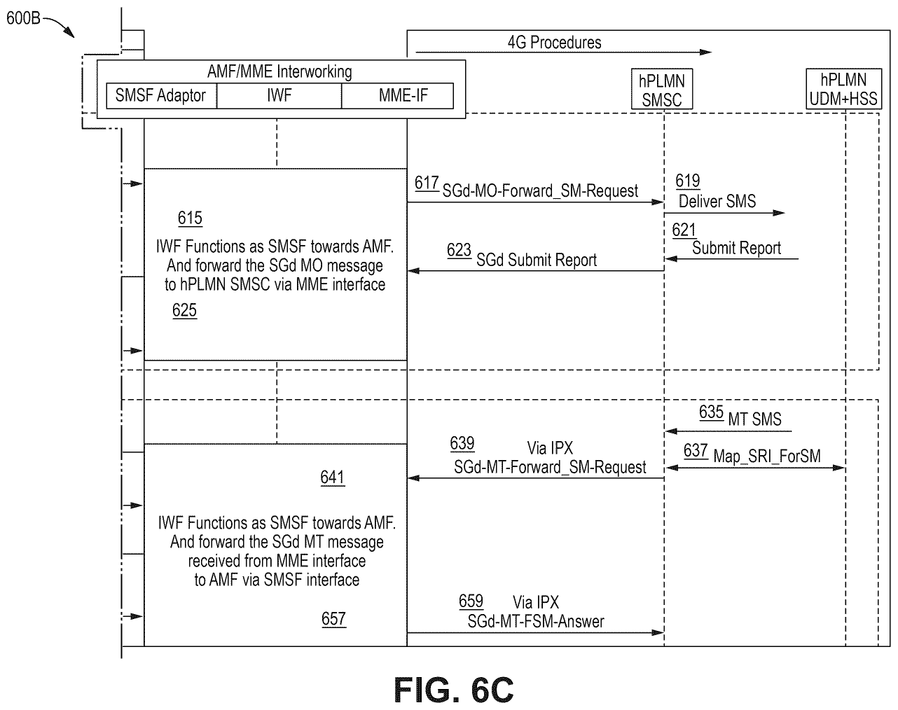

FIGS. 3A, 3B, and 3C, 4A, 4B, and 4C, 5A, 5B, and 5C, and 6A, 6B, and 6C illustrate example implementations of using the functions of the interworking component 150 to perform roaming for 5G capable UE with various services, including registration and authentication procedure illustrated in FIGS. 3A, 3B, and 3C, PDU user plane session procedure illustrated in FIGS. 4A, 4B, and 4C, PDU control plane session procedure illustrated in FIGS. 5A, 5B, and 5C, and SMS procedure illustrated in FIGS. 6A, 6B, and 6C.

Referring to FIG. 3A, 5G registration and authentication requests may go through N1/N2 interfaces to AMF, and AMF may relay the requests through N12 or N8 interface to the interworking component 150. The interworking component 150 may convert the requests in 5G context to 4G context and send it through S6a interface to 4G hPLMN for processing. After 4G hPLMN processes the requests, 4G hPLMN may send a response using the same route back to 5G vPLMN. The detail procedure is illustrated with respect to FIGS. 3B and 3C.

Referring to FIGS. 3B and 3C, UE (e.g., UE 210) may send a registration request 311 (e.g., NAS message over NG Application Protocol (NGAP)) via gNB (e.g., RAN 221) to AMF (e.g., AMF 234), and the registration request may include the identifier of UE (e.g., international mobile subscriber identity (IMSI)), the capability of UE and supported network features. AMF may send the received information 313 to the interworking component 150, where the interworking component 150 includes an AUSF/UDM adaptor (e.g., AUSF/UDM adaptor 251) that can ingress the information to IWF (e.g., IWF 259) of the interworking component 150. IWF converts 315 the 5G context information (e.g., HTTP2 AUSF request) to corresponding information in 4G context (e.g., 4G Diameter AIR). The IWF may use MME interface adaptor (e.g., MME interface adaptor 252, 256) to output the 4G context corresponding information 317 (e.g., authentication information request/diameter) to 4G hPLMN. The corresponding component (e.g., HSS) of the 4G hPLMN may use the 4G context corresponding information to perform the authentication to authorize UE, create UE context, and send an authentication response 319 (e.g., authentication information response/diameter) to the interworking component 150. The MME interface adaptor of the interworking component 150 may ingress the authentication response, and IWF of interworking component 150 may convert 321 the authentication response in 4G context to 5G context. The AUSF/UDM adaptor of interworking component 150 may send the 5G context authentication response 323 to AMF. AMF may send the information 325 through gNB to UE. UE may continue the registration and authentication procedure within the 5G vPLMN through the steps 327, 329, 331, 333, 335, 337, 339 until 5G NAS security connection 341 is established to UE.

Referring to FIGS. 3B and 3C regarding UDM, AMF can transmit the information 343, 345, 347 to the interworking component 150. The interworking component 150 can ingress these information via AUSF/UDM adaptor (e.g., AUSF/UDM adaptor 251), convert 349 incoming 5G context information (e.g., HTTP2 UDM request) to corresponding information in 4G context (e.g., 4G Diameter AIR), and use MME interface adaptor (e.g., MME interface adaptor 252, 256) to output the 4G context corresponding information 351 to 4G hPLMN. The corresponding component (e.g., HSS) of the 4G hPLMN may use the 4G context corresponding information to process and send a response 353 to the interworking component 150. The MME interface adaptor of the interworking component 150 may ingress the response, and IWF of interworking component 150 may convert 355 the response in 4G context to 5G context. The AUSF/UDM adaptor of interworking component 150 may send the 5G context response 357 to AMF.

Referring to FIG. 4A, 5G PDU user plane session requests may go through N1/N2 interfaces to AMF, and AMF may relay the requests through N11 interface to the interworking component 150. The interworking component 150 may convert the requests in 5G context to 4G context and send it through S11 interface to 4G hPLMN for processing. After 4G hPLMN processes the requests, 4G hPLMN may send a response using the same route back to 5G vPLMN. The detail procedure is illustrated with respect to FIGS. 4B and 4C.

Referring to FIGS. 4B and 4C, UE (e.g., UE 210) may send a PDU session establishment request 411 via gNB (e.g., RAN 221) to AMF (e.g., AMF 234). AMF may send the received information 413 to the interworking component 150, where the interworking component 150 includes an SMF adaptor (e.g., SMF adaptor 255) that can ingress the information to IWF (e.g., IWF 259) of the interworking component 150. IWF converts 415 the 5G context information (e.g., 5G session create request) to corresponding information in 4G context (e.g., 4G Diameter CSR request). The IWF may use MME interface adaptor (e.g., MME interface adaptor 252, 256) to send the 4G context corresponding information 417 to SGW adaptor (e.g., SGW adaptor 254). The SGW adaptor may send the information 419 to 4G hPLMN. The corresponding component (e.g., PGW 275) of the 4G hPLMN may use the 4G context corresponding information to perform the related service of session creation and send response 421 to the interworking component 150. The SGW adaptor of the interworking component 150 may ingress the response 421 and relay 423 to MME interface adaptor, and IWF of interworking component 150 may convert 425 the response in 4G context to 5G context. The SMF adaptor of interworking component 150 may send the 5G context response 427 to AMF. The SMF adaptor may send N4 session establishment request 429 to UPF adaptor (e.g., UPF adaptor 254) of interworking component 150, and receive N4 session establishment response 431 from UPF adaptor. The SMF adaptor may send the response 433 to AMF. UE and gNB may continue the PDU user plane session procedure within the 5G vPLMN through the steps 435, 437, and 439 until uplink data 441 is sent to 4G hPLMN.

Referring to FIGS. 4B and 4C regarding updating of session, AMF can transmit the information 443 to the interworking component 150. The SMF adaptor may send N4 session establishment/modification request 445 to UPF adaptor (e.g., UPF adaptor 254) of interworking component 150, and receive N4 session establishment/modification response 447 from UPF adaptor. The interworking component 150 can ingress these information via SMF adaptor (e.g., SMF adaptor 255), convert 449 incoming 5G context information (e.g., 5G SM context update) to corresponding information in 4G context (e.g., 4G modify bearer request), and use MME interface adaptor (e.g., MME interface adaptor 252, 256) to output the 4G context corresponding information 453, 455 via SGW adaptor to 4G hPLMN. The corresponding component (e.g., PGW 275) of the 4G hPLMN may use the 4G context corresponding information to process and send downlink data 457 to UE.

Referring to FIG. 5A, 5G PDU control plane session requests may go through N1/N2 interfaces to AMF, and AMF may relay the requests through N11 interface to the interworking component 150. The interworking component 150 may convert the requests in 5G context to 4G context and send it through T6ai interface to 4G hPLMN for processing. After 4G hPLMN processes the requests, 4G hPLMN may send a response using the same route back to 5G vPLMN. The detail procedure is illustrated with respect to FIGS. 5B and 5C.

Referring to FIGS. 5B and 5C, UE (e.g., UE 210) may send a PDU session establishment request 511 via gNB (e.g., RAN 221) to AMF (e.g., AMF 234). AMF may send the received information 513 to the interworking component 150, where the interworking component 150 includes an SMF adaptor (e.g., SMF adaptor 255) that can ingress the information to IWF (e.g., IWF 259) of the interworking component 150. IWF converts 515 the 5G context information (e.g., 5G session create request) to corresponding information in 4G context. The IWF may use MME interface adaptor (e.g., MME interface adaptor 252, 256) to send the 4G context corresponding information 517 to IWF-SCEF (e.g., IWF-SCEF 278). The IWF-SCEF may send the information 519 to 4G hPLMN. The corresponding component (e.g., SCEF 277) of the 4G hPLMN may use the 4G context corresponding information to perform the related service of session creation and send response 521 to IWF-SCE. IWF-SCEF may relay the information 523 to the interworking component 150. The MME interface adaptor of the interworking component 150 may ingress the response 523, and IWF of interworking component 150 may convert 525 the response in 4G context to 5G context. The SMF adaptor of interworking component 150 may send the 5G context response 527 to AMF. UE and gNB may continue the PDU control plane session procedure within the 5G vPLMN through the steps 529, 531, 533, 535, and 537. AMF can transmit the information 539 to the interworking component 150. The interworking component 150 can ingress these information via SMF adaptor (e.g., SMF adaptor 255), convert 541 incoming 5G context information (e.g., 5G Mo data) to corresponding information in 4G context (e.g., 4G create SCEF connection request), and use MME interface adaptor (e.g., MME interface adaptor 252, 256) to output the 4G context corresponding information 543, 545 via IWF-SCEF to 4G hPLMN. The corresponding component (e.g., SCEF 277) of the 4G hPLMN may use the 4G context corresponding information to process and send response 547 to IWF-SCEF, and IWF-SCEF may relay the information 549 to the interworking component 150. The MME interface adaptor of the interworking component 150 may ingress the response 549, and IWF of interworking component 150 may convert 551 the response in 4G context to 5G context. The SMF adaptor of interworking component 150 may send the 5G context response 553 (HTTP response 204 No Content) to AMF.

Referring to FIG. 6A, 5G SMS requests may go through N1/N2 interfaces to AMF, and AMF may relay the requests through N20 interface to the interworking component 150. The interworking component 150 may convert the requests in 5G context to 4G context and send it through SGd interface to 4G hPLMN for processing. After 4G hPLMN processes the requests, 4G hPLMN may send a response using the same route back to 5G vPLMN. The detail procedure is illustrated with respect to FIGS. 6B and 6C.

Referring to FIGS. 6B and 6C, UE (e.g., UE 210) may send a service request and SMS data 611 via gNB (e.g., RAN 221) to AMF (e.g., AMF 234). AMF may send the received information 613 to the interworking component 150, where the interworking component 150 includes an SMSF adaptor (e.g., SMSF adaptor 253) that can ingress the information to IWF (e.g., IWF 259) of the interworking component 150. IWF converts 615 the 5G context information to corresponding information in 4G context. The IWF may use MME interface adaptor (e.g., MME interface adaptor 252, 256) to send the 4G context corresponding information 617 to SMSC (e.g., SMSC 273). The SMSC may send the SMS 619 to 4G hPLMN. The corresponding component (e.g., HSS) of the 4G hPLMN may receive the 4G context corresponding information and send response 621 to SMSC. SMSC may relay the information 623 to the interworking component 150. The MME interface adaptor of the interworking component 150 may ingress the response 623, and IWF of interworking component 150 may convert 625 the response in 4G context to 5G context. The SMF adaptor of interworking component 150 may send the 5G context response 627 to AMF. UE and gNB may continue the SMS procedure within the 5G vPLMN through the steps 629, 631, and 633. The SMS procedure can be in a reversed direction as shown in steps 635 to 659. In a reversed direction where there is a SMS request sent towards UE 210 in roaming, the terminating SMS request 635 may be sent towards SMSC in the 4G hPLMN. 4G hPLMN SMSC may query 637 towards hPLMN HSS to acquire the UE 210 status and get the roaming network information (AMF in vPLMN). 4G hPLMN SMSC may forward the SMS 639 to MME interface adaptor. IWF may forward 641 the SMS message received from MME interface to AMF via SMSF adaptor, which interacts with AMF in 643, 647 to page 645 the UE. AMF 647 may notify SMSF adaptor that UE is reachable. SMSF adaptor may use 649 to forward SMS message to AMF, AMF may use 651 to send SMS to UE. UE may confirm reception of SMS in 653 to AMF. AMF may confirm the delivery of SMS to SMSF adaptor in 655. IWF converts 657 the received 655 context from 5G to 4G and confirms back to SMSC in hPLMN in 659.

In some implementations, a system (e.g., system 100 in FIG. 1, system 200 in FIG. 2, or system 300 in FIG. 3) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, system 200 in FIG. 2, or system 300 in FIG. 3) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a UPF resource manager (e.g., the interworking component 150 of FIGS. 1-3).

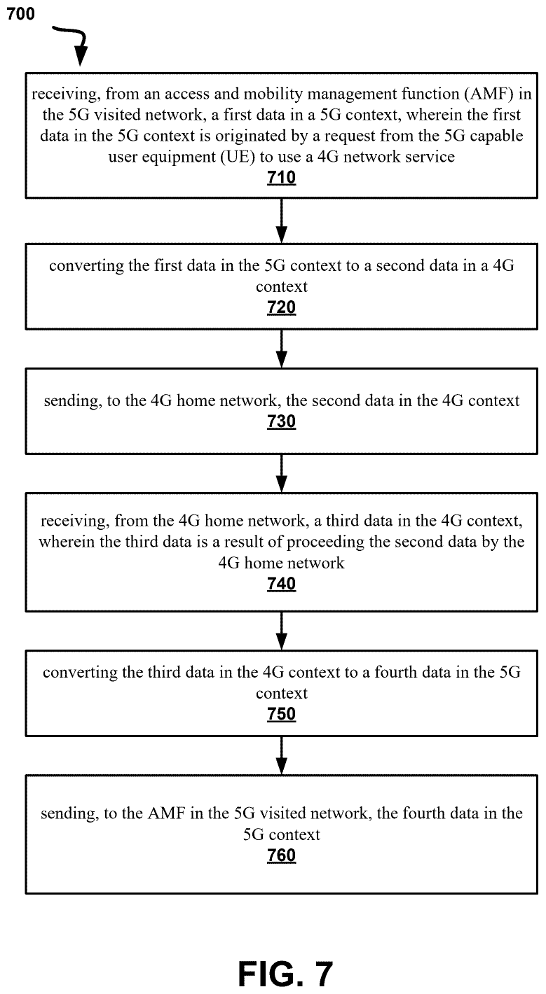

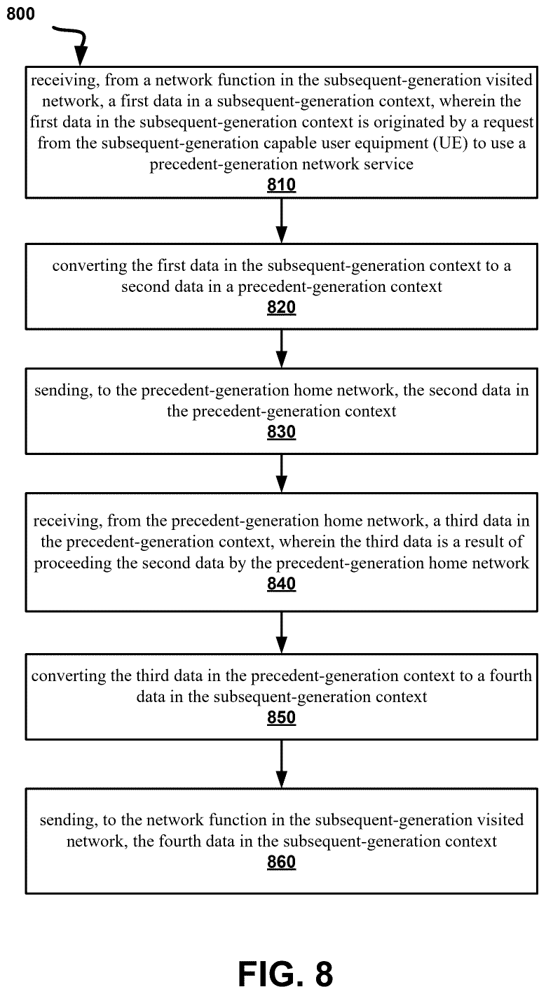

FIGS. 7 and 8 are flow diagrams of methods 700 and 800 of implementing seamless roaming solution for a next generalization cellular network capable user equipment (UE) in heterogeneous network environments according to at least one embodiment. The methods 700 and 800 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 700 and 800 are performed by the system 100 of FIG. 1. In one embodiment, the methods 700 and 800 are performed by the interworking component 150 of FIGS. 1-6B.

Referring to FIG. 7, at operation 710, the processing logic may receive, from an access and mobility management function (AMF) in the 5G visited network, a first data in a 5G context, wherein the first data in the 5G context is originated by a request from the 5G capable user equipment (UE) to use a 4G network service. At operation 720, the processing logic may convert the first data in the 5G context to a second data in a 4G context. At operation 730, the processing logic may send, to the 4G home network, the second data in the 4G context. In some implementations, the determined value is higher than a currently-used value of the resource parameter of the UPF. At operation 740, the processing logic may receive, from the 4G home network, a third data in the 4G context, wherein the third data is a result of processing the second data by the 4G home network. At operation 750, the processing logic may convert the third data in the 4G context to a fourth data in the 5G context. At operation 760, the processing logic may send, to the AMF in the 5G visited network, the fourth data in the 5G context.

In some implementations, the request comprises a UE registration and authentication request, wherein the first data is received via an authentication server function (AUSF) adaptor or a unified data management (UDM) adaptor, wherein the second data is sent via a mobility management entity (MME) interface adaptor, wherein the third data is received via the MME interface adaptor, and wherein the fourth data is received via the AUSF adaptor or the UDM adaptor.

In some implementations, the request comprises a user plane based packet data unit (PDU) session request, wherein the first data is received via a session management function (SMF) adaptor, wherein the second data is sent via a mobility management entity (MME) interface adaptor, wherein the third data is received via the MME interface adaptor, and wherein the fourth data is received via the SMF adaptor.

In some implementations, the request comprises a control plane based packet data unit (PDU) session request, wherein the first data is received via a session management function (SMF) adaptor, wherein the second data is sent via a mobility management entity (MME) interface adaptor, wherein the third data is received via the MME interface adaptor, and wherein the fourth data is received via the SMF adaptor.

In some implementations, the request comprises a short message service request, wherein the first data is received via a short message service function (SMSF) adaptor, wherein the second data is sent via a mobility management entity (MME) interface adaptor, wherein the third data is received via the MME interface adaptor, and wherein the fourth data is received via the SMSF adaptor.

In some implementations, a first adaptor is used for sending and receiving data in a 5G context, and a second adaptor is used for sending and receiving data in a 4G context.

In some implementations, the processing logic may convert the first data in the 5G context to the second data in the 4G context by at least one of: translating information from a 5G procedure into a 4G procedure, or converting a 5G identity to a 4G identity.

In some implementations, the processing logic may convert the third data in the 4G context to the fourth data in the 5G context by at least one of: translating information from a 4G procedure into a 5G procedure, or converting a 4G identity to a 5G identity.

Referring to FIG. 8, at operation 810, the processing logic may receive, from a network function that handles connection and mobility management tasks in the subsequent-generation visited network, a first data in a subsequent-generation context, wherein the first data in the subsequent-generation context is originated by a request from the subsequent-generation capable user equipment (UE) to use a precedent-generation network service. At operation 820, the processing logic may convert the first data in the subsequent-generation context to a second data in a precedent-generation context. At operation 830, the processing logic may send, to the precedent-generation home network, the second data in the precedent-generation context. In some implementations, the determined value is higher than a currently-used value of the resource parameter of the UPF. At operation 840, the processing logic may receive, from the precedent-generation home network, a third data in the precedent-generation context, wherein the third data is a result of processing the second data by the precedent-generation home network. At operation 850, the processing logic may convert the third data in the precedent-generation context to a fourth data in the subsequent-generation context. At operation 860, the processing logic may send, to the network function in the subsequent-generation visited network, the fourth data in the subsequent-generation context. In some implementations, the network function comprises an access and mobility management function (AMF).

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of enabling seamless roaming of a fifth generation (5G) capable user equipment (UE) from a fourth generation (4G) home network to a 5G visited network, the method comprising:
receiving, from an access and mobility management function (AMF) in the 5G visited network, a first data in a 5G context, wherein the first data in the 5G context is originated by a request from the 5G capable user equipment (UE) to use a 4G network service;
converting the first data in the 5G context to a second data in a 4G context;
sending, to the 4G home network, the second data in the 4G context;
receiving, from the 4G home network, a third data in the 4G context, wherein the third data is a result of processing the second data by the 4G home network;
converting the third data in the 4G context to a fourth data in the 5G context; and
sending, to the AMF in the 5G visited network, the fourth data in the 5G context.

2. The method of claim 1, wherein the request comprises a UE registration and authentication request, wherein the first data is received via an authentication server function (AUSF) adaptor or a unified data management (UDM) adaptor, wherein the second data is sent via a mobility management entity (MME) interface adaptor, wherein the third data is received via the MME interface adaptor, and wherein the fourth data is received via the AUSF adaptor or the UDM adaptor.

3. The method of claim 1, wherein the request comprises a user plane based packet data unit (PDU) session request, wherein the first data is received via a session management function (SMF) adaptor, wherein the second data is sent via a mobility management entity (MME) interface adaptor, wherein the third data is received via the MME interface adaptor, and wherein the fourth data is received via the SMF adaptor.

4. The method of claim 1, wherein the request comprises a control plane based packet data unit (PDU) session request, wherein the first data is received via a session management function (SMF) adaptor, wherein the second data is sent via a mobility management entity (MME) interface adaptor, wherein the third data is received via the MME interface adaptor, and wherein the fourth data is received via the SMF adaptor.

5. The method of claim 1, wherein the request comprises a short message service request, wherein the first data is received via a short message service function (SMSF) adaptor, wherein the second data is sent via a mobility management entity (MME) interface adaptor, wherein the third data is received via the MME interface adaptor, and wherein the fourth data is received via the SMSF adaptor.

6. The method of claim 1, wherein a first adaptor is used for sending and receiving data in a 5G context, and a second adaptor is used for sending and receiving data in a 4G context.

7. The method of claim 1, wherein converting the first data in the 5G context to the second data in the 4G context further comprises at least one of: translating information from a 5G procedure into a 4G procedure, or converting a 5G identity to a 4G identity.

8. The method of claim 1, wherein converting the third data in the 4G context to the fourth data in the 5G context further comprises at least one of: translating information from a 4G procedure into a 5G procedure, or converting a 4G identity to a 5G identity.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving, from a network function that handles connection and mobility management tasks in a subsequent-generation visited network, a first data in a subsequent-generation context, wherein the first data in the subsequent-generation context is originated by a request from a subsequent-generation capable user equipment (UE) to use a precedent-generation network service;
converting the first data in the subsequent-generation context to a second data in a precedent-generation context;
sending, to a precedent-generation home network, the second data in the precedent-generation context;
receiving, from the precedent-generation home network, a third data in the precedent-generation context, wherein the third data is a result of processing the second data by the precedent-generation home network;
converting the third data in the precedent-generation context to a fourth data in the subsequent-generation context; and
sending, to the network function in the subsequent-generation visited network, the fourth data in the subsequent-generation context.

10. The computing system of claim 9, wherein the network function comprises an access and mobility management function (AMF).

11. The computing system of claim 9, wherein a first adaptor is used for sending and receiving data in the subsequent-generation context, and a second adaptor is used for sending and receiving data in the precedent-generation context.

12. The computing system of claim 9, wherein converting the first data in the subsequent-generation context to the second data in the precedent-generation context further comprises at least one of: translating information from a subsequent-generation procedure into a precedent-generation procedure, or converting a subsequent-generation identity to a precedent-generation identity.

13. The computing system of claim 9, wherein converting the third data in the precedent-generation context to the fourth data in the subsequent-generation context further comprises at least one of: translating information from a precedent-generation procedure into a subsequent-generation procedure, or converting a precedent-generation identity to a subsequent-generation identity.

14. One or more non-transitory, computer-readable storage media having computer-readable instructions thereon which, when executed by one or more processing devices, cause the one or more processing devices to perform operations comprising:
receiving, from a network function that handles connection and mobility management tasks in a subsequent-generation visited network, a first data in a subsequent-generation context, wherein the first data in the subsequent-generation context is originated by a request from a subsequent-generation capable user equipment (UE) to use a precedent-generation network service;
converting the first data in the subsequent-generation context to a second data in a precedent-generation context;
sending, to a precedent-generation home network, the second data in the precedent-generation context;
receiving, from the precedent-generation home network, a third data in the precedent-generation context, wherein the third data is a result of processing the second data by the precedent-generation home network;
converting the third data in the precedent-generation context to a fourth data in the subsequent-generation context; and
sending, to the network function in the subsequent-generation visited network, the fourth data in the subsequent-generation context.

15. The one or more non-transitory, computer-readable storage media of claim 14, wherein the network function comprises an access and mobility management function (AMF).

16. The one or more non-transitory, computer-readable storage media of claim 14, wherein the request comprises a UE registration and authentication request, wherein the first data is received via an authentication server function (AUSF) adaptor or a unified data management (UDM) adaptor, wherein the second data is sent via a mobility management entity (MME) interface adaptor, wherein the third data is received via the MME interface adaptor, and wherein the fourth data is received via the AUSF adaptor or the UDM adaptor.

17. The one or more non-transitory, computer-readable storage media of claim 14, wherein the request comprises a user plane based packet data unit (PDU) session request, wherein the first data is received via a session management function (SMF) adaptor, wherein the second data is sent via a mobility management entity (MME) interface adaptor, wherein the third data is received via the MME interface adaptor, and wherein the fourth data is received via the SMF adaptor.

18. The one or more non-transitory, computer-readable storage media of claim 14, wherein the request comprises a control plane based packet data unit (PDU) session request, wherein the first data is received via a session management function (SMF) adaptor, wherein the second data is sent via a mobility management entity (MME) interface adaptor, wherein the third data is received via the MME interface adaptor, and wherein the fourth data is received via the SMF adaptor.

19. The one or more non-transitory, computer-readable storage media of claim 14, wherein the request comprises a short message service request, wherein the first data is received via a short message service function (SMSF) adaptor, wherein the second data is sent via a mobility management entity (MME) interface adaptor, wherein the third data is received via the MME interface adaptor, and wherein the fourth data is received via the SMSF adaptor.

20. The one or more non-transitory, computer-readable storage media of claim 14, wherein converting the first data in the subsequent-generation context to the second data in the precedent-generation context further comprises at least one of: translating information from a subsequent-generation procedure into a precedent-generation procedure, or converting a subsequent-generation identity to a precedent-generation identity.
